(19) United States
(12) Patent Application Publication
(10) Pub. No.: US 2016/0120722 A1
(43) Pub. Date: May 5, 2016

(54) LIFT

(71) Applicant: Peter A. MUELLER, (US)

(72) Inventor: Peter A. MUELLER, Gattikon (CH)

(21) Appl. No.: 14/767,747

(22) PCT Filed: Dec. 3, 2013
(86) PCT No.: PCT/CH2013/000211

§ 371 Date: Jan. 5, 2016

(30) Foreign Application Priority Data
Dec. 3, 2012 (CH) 2670/12

(51) Int. Cl. A61G 7/10; E04H 4/14; E04H 4/12; B66B 9/00

(52) U.S. Cl. CPC A61G 7/1005; B66B 9/00; E04H 4/144; E04H 4/1245; E04H 4/1281

(57) ABSTRACT

A lift with guide rails and guide device and by using a cable winch reduction, an electric drive or a hydraulic cylinder enables a lift platform or a double platform to move vertically over a lifting and the swimming pool lift includes a flotation body, which can receive the drive, the hydraulic system and the swimming pool cleaning system.

### TECHNICAL FIELD

The invention relates to a lift which overcomes terrestrial obstacles and is also suitable for swimming pool basins according to the preamble of the first claim.

### STATE OF THE ART

Confidence in elevators has been strengthened since the invention of the safety features of Otis in 1853, and thus a large number of patents have been filed with respect to elevators with corresponding lifting and security mechanisms, as well as with and without counterweights, as described, for example, in U.S. Pat. No. 2,086,002.

Lifts are also known in the form of stair lifts or hoists, such as, inter alia, FR 2877656. In addition, solutions have been created for swimming pool basins, in particular for individuals with disabilities, so that they may also enjoy the possibility of swimming, as described, inter alia, in the U.S. Pat. No. 7,275,272 B2, U.S. Pat. No. 4,283,803, U.S. Pat. No. 5,432,961.

### SUMMARY OF THE INVENTION

The invention relates to a vertically or obliquely traversing lift in the terrestrial area for the transport of goods and people and for the swimming pool area for individuals with reduced mobility, such as seniors or mothers with their small children, but also for athletes, i.e. for recreational use, sports and rehabilitation, wherein the lift system is additionally as self-supporting as possible in water by means of flotation bodies, according to the preamble of the first claim.

To ensure that the obligation in public facilities of barrier-free access to a swimming pool is met, but also that the swimming pool may be used as diversely as possible in private areas, a swimming pool lift is an efficient solution for transporting people into or out of the water and a comfortable device to serve simultaneously as a carrier for fitness and other devices or as a diving platform.

The inventive approach is to operate such a facility for the terrestrial as well as swimming pool area with parts which are as identical as possible, with a simple drive and a security disposition which eliminates a falling of the lift platform in every case and which, in case of emergency, allows this to be driven to the best lifting position, even without electricity.

In addition to the equipment standards with respect to safety distances, in order not to clamp a limb, the safety aspect therefore comprises covers to prevent shearing points, a spring-loaded safety cable, a gas spring or hydraulic accumulator or battery powered back-up solution, and, in the swimming pool area, an additional flotation body or an emergency flotation system similar to an airbag. This ensures that, during a failure of the drive, the platform of the swimming pool lift cannot ever fall down or that, during an electrical failure, the hydraulics can be released by means of actuation of an depressurization switch and, due to the gas spring force or integration of the hydraulic accumulator, or by means of sufficient flotation force of the flotation body or filling of gas of a folded plastic bag, which in its inflated state forms a flotation pillow, the platform can thus be lifted to the desired position.

In addition, load-bearing structures in indoor pools are subjected to exceptionally rigorous safety regulations, which means that stainless steel far above the quality of standard stainless steel, thus higher quality and very expensive stainless steel, must be used. Therefore, the platform is underlaid with floating bodies, so that in the corrosive environment of the chlorine-containing air in a swimming pool, in the case of a material failure, the platform cannot quickly sink downward and unluckily contact a swimmer, but would then slowly sink in the water like a leaky raft. For this reason, a low-cost stainless steel can be used, such as that according to DIN standard 1.4404 or 1.4462.

Although for the terrestrial area the water element is lacking and thus the use of flotation bodies, such required safety can nevertheless be achieved with very good result by means of a corresponding cable lock or double-guided cable.

Identically to the swimming pool lift, an excellent reduction of the drive can be ensured without an elaborate gear ratio by means of a large cable winding winch and a force locking small cable winding winch applied thereto, said drive being driven by means of a linear drive, such as a hydraulic cylinder, with a small stroke or small hydraulic motor. The lifting cylinder, as well as a rotating motor, can be operated electrically or by means of a fluid, such as bio-oil or plain water.

A hydraulic motor or an electric motor requires an additional lock to secure the angular position of the motor. In contrast, a hydraulic cylinder requires only a load retaining valve in order to hydraulically lock the position of the piston rod.

The reduction ratio multiplies itself by means of a pulley and cable winch, and acts as a kind of potency pulley.

This is achieved according to the invention through the features of the first claim.

The essence of the invention is, by means of a reduction cable winch and a lift platform mounted on guide rods, to render said lift platform accident-proof by means of a safety cable and a back-up system or and a solid or inflatable flotation body, and to integrate the entire drive of the platform lifter together with the reduction, hydraulic accumulator and control into the large cable winch.

Further advantageous embodiments of the invention result from the dependent claims.

### BRIEF DESCRIPTION OF THE DRAWINGS

Exemplary embodiments will be described in more detail hereinafter with reference to drawings. Identical elements in the various figures are provided with the same reference characters.

FIG. 1 shows a schematic side view of a swimming pool lift on a swimming pool basin with guide rails and guide rollers on the lift platform, an external drive on the guide rails with a floor-laid cable or an interchangeable battery pack, the drive is connected with the lift platform by means of a cable and the lift platform comprises a flotation body, in which a swimming pool purification system is recessed or this is fixed in a separate holder on the swimming pool wall and a separate flotation body is located on the guide rails.

FIG. 2 shows a schematic side view of a swimming pool lift on a swimming pool basin with guide rails, lifting-limiting means and guide slide bushings on the lift platform, a hydraulic drive in the swimming body wherein the cable end is fixed in the area of the swimming pool basin floor and comprises a safety cable, as well as a hydraulic cylinder and a hydraulic accumulator which are fixed in the swimming body.

FIG. 3 shows a schematic side view of a terrestrial lift with guide rails, guide side bushings on the lift platform and a hydraulic drive, as well as a gas spring in a covered banister side with emergency control and a motor-operated door, as well as a clasping of the lift platform by means of a cable, which is guided by two rollers.

FIG. 4 shows a schematic side view of a drive with integrated hydraulic system with the cable winch, the cable winch reduction, the hydraulic cylinder and the controller, as well as a power supply by means of an inductive contact.

FIG. 5 shows a schematic side view of a drive with integrated hydraulic, with the cable winch, the cable winch reduction, the pulley, controller and the power supply through the first cable.

FIG. 6 shows a schematic side view of a terrestrial lift with guide rails and guide bushings, on which a lift platform and a platform lifter are located in a covered housing, as well as a double platform, each with two pivoting levers and a stop plate on both sides.

FIG. 7 shows a schematic side view of a terrestrial lift with guide rails, on which a variable lift platform and a platform lifter are located in a covered housing, each with two pivoting levers and a stop plate on both sides.

Only elements which are essential for the immediate understanding of the invention are shown schematically.

### MODE FOR CARRYING OUT OF THE INVENTION

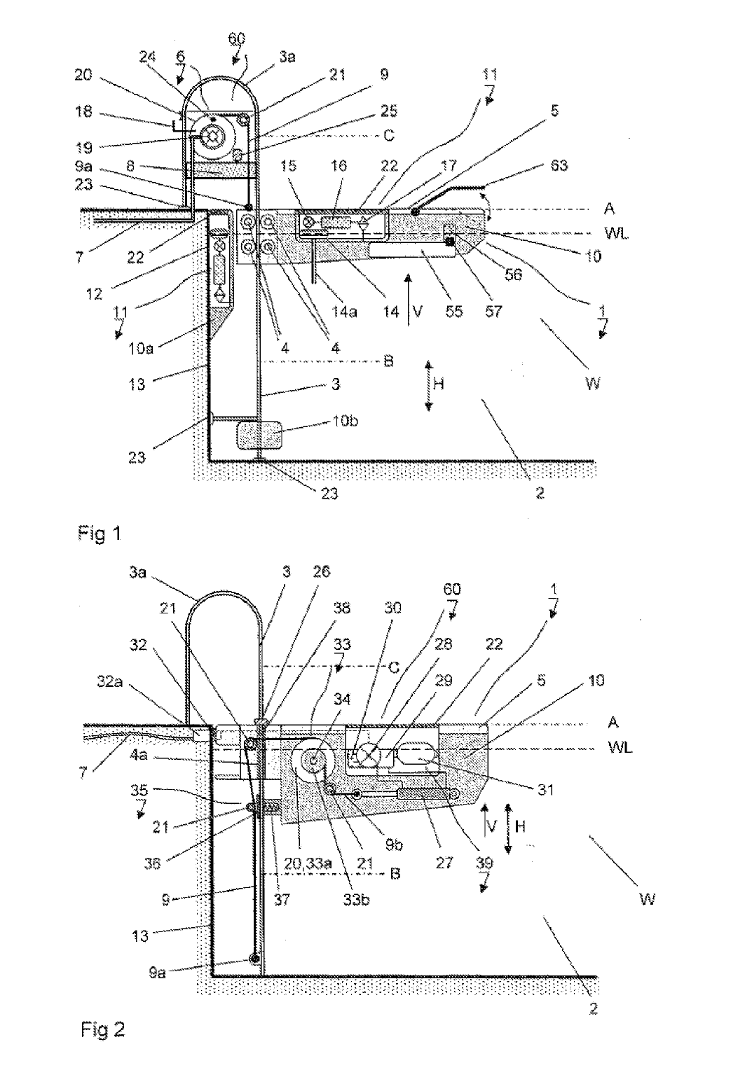

FIG. 1 shows a schematic side view of a swimming pool lift 1 on a swimming pool basin 2 filled with water W with guide rails 3 and guide rollers 4 on the lift platform 5, an external drive 6 on the guide rails 3 with a floor-laid cable 7 or an interchangeable battery pack 8 and the cable winch 20, fixed on the drive 6, is connected with the lift platform 5 with the cable 9 and the lift platform 5 comprises a flotation body 10, in which a swimming pool purification system 11 is recessed or this is fixed in a separate holder 12 on the swimming pool wall 13 and a separate flotation body 10a is located on the guide rails 3.

Swimming pool basins 2 are not designed to receive a swimming pool lift 1. In addition, the legal requirements regarding support structures are rigorous, as intergranular corrosion may form in chlorinated water and such a part may break away without warning or the appearance of rust, and may thus have fatal consequences. Many private swimming pool basins 2 are hardly suitable for bores with tensile-loaded attachments, particularly if they have a covering. This limitation reduces to a high degree the ability to inexpensively use such a swimming pool lift 1. This is unfortunate, as thus many less-mobile persons, for example seniors, mothers with their small children or disabled individuals, continue to have trouble getting out of the water.

A swimming pool lift 1 is the optimal device for this and may, if kinematics permit, be driven out above the swimming pool basin edge and thus be used as a diving platform or allow the attachment of sports equipment thereon. Such a swimming pool lift 1 may also serve as a basis for diverse sport activities, such as aquabiking or aquarunning, in that the person drives the swimming pool lift 1 to an individual depth in the water until the most comfortable or most effective underwater position for the fitness program has been reached.

Such a swimming pool lift 1 is usually a large device, as it is possible that more than one person wishes to stand on such a platform or a wheelchair with an assisting individual requires space thereon. In addition to the empty weight and the people thereon, this requires a considerably strong lift motor or cylinder. The inventive solution is to massively reduce the empty weight of the swimming pool lift 1, as well as the integrated accessories by means of a flotation body 10 in the water, so that the lift motor or cylinder continues to have a heavy load due to move due to the reduction ratio described here, however a lower rotational speed, respectively less lifting, is required at the cylinder for this purpose.

In addition, the space required for such a swimming pool lift 1 is to be optimally used, thus for example as described above as a basis for sports equipment, however not only, but rather simultaneously as a means for cleaning and disinfecting the swimming pool basin 2 in the form of a swimming pool cleaning system 11. A swimming pool basin 2 thus requires no separate space and wall penetration of the swimming pool basin 2 in order to keep the water clean. The direct exchange of polluted water by means of an inlet at the skimmer 14, which has a coarse filter for foliage, etc., into the circulation pump 15, then to the filter 16 and finally the addition of chemical agents, such as chlorine as a disinfectant, by means of a metering device 17, which also imparts flocculants, etc., to the water W at the appropriate time, either time-controlled or via command from a water quality probe or disinfection of the water W by means of chemical-free UV light, etc., thus has a short purification path, unloads the circulation pump 15 and thus saving energy, and improves the overall circulation in the swimming pool basin 2. If the space in the flotation body 10 is completely required for the drive 6, as is shown in FIG. 2, the swimming pool cleaning system 11 may thus be housed in a container 12 on the wall of the swimming pool basin 2. This may be connected with the guide rails 3 instead of on the wall and may also serve in this location as a further flotation body 10a with the corresponding volume of the container 12.

Besides the possibility of using the swimming pool lift 1 as a carrier for the swimming pool cleaning system 11, the swimming pool lift 1 may also be used as a means for sport, as is described in FIG. 2, where the lift platform 5 may be driven out above the edge of the swimming pool basin 2, and thus form a diving platform. Instead, a fold-out diving board 63 may be tilted up from the lift platform 5, which diving board may likewise form a diving platform. The tilting up may occur manually or electrically or hydraulically. In addition, a waterfall and a corresponding LED lighting can be attached to the fold-out diving board 63, thus creating a special ambiance.

The external platform lifter 60 shows an electric drive 6. If this is located outside and behind the swimming pool basin 2, this may also be operated with AC power, which is fixed to the handrail 3a, which is a part of the guide rail 3. Not shown is a variant of reduction of the motor rotational speed by means of a planetary gear unit or the variants as shown in FIG. 2-4. The locking of the lifting by means of the liftingstop 18 may be actuated automatically or also manually and has a crank opening 19, so that the lift platform 5 can always be lifted at a technical panel by means of a hand crank. The cable winch on which the cable 9 is fixed is located at the drive 6, and this, deflected by means of the deflection roller 21, is affixed to the lift platform 5 by means of the cable end 9a. The cable 9 may also be a flat belt, which has the advantage that the strands lie adjacent to each other and are coated with plastic, thus corrosion can be virtually eliminated and the bending radius at the deflection rollers 21 can be selected to be smaller.

The lift platform 5 has guide rollers 4, which encompass the guide rails 3. The flotation body 10 is attached to the lift platform 5 and contains the swimming pool cleaning system 11, which has a waterproof lid 22, so that access to the mechanics lying thereunder, for instance for filter replacement, is always possible. If the swimming pool cleaning system 11 is housed in the container 11 on the wall of the swimming pool basin 2, a lid 22 is present there, too, for inspection and servicing of the system.

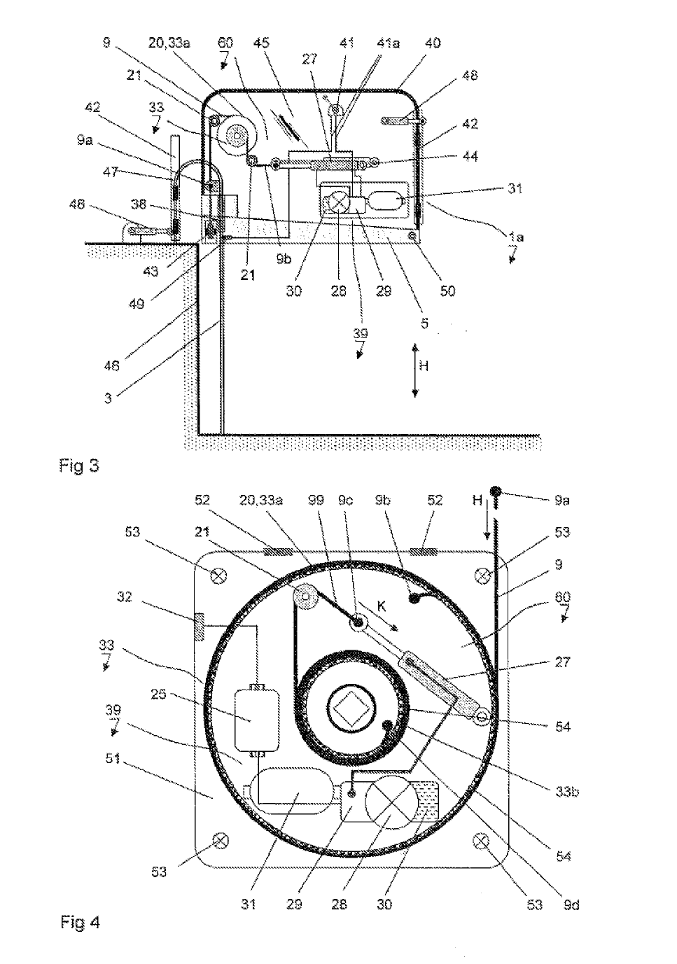

The flotation body 10 may not compensate for the full empty weight of the swimming pool lift 1 with the drive V, as the lift platform 5 could not then be lowered. The drive 6 must then always provide a residual force in order to guide the lift platform 5 upward. For emergencies, a gas spring 44 can additionally be mounted on the drive 6, as is shown in FIG. 3, so that it is always ensured that even in the case of a hydraulic or electrical defect, the lift platform 5 can be completely lifted, including a person, for example.

Alternatively, an air bag 55 with a compressed air filling means 56 can be mounted under the lift platform 5, which can be opened in an emergency by means of the manual valve 57 and thus the filling means 56 flows into the air bag 55, inflating said air bag 55 and forming a flotation body 10, which lifts the lift platform 5 upward. Such an air bag 55 with a 200 L volume thus results in a drive of approximately 200 kg, sufficient to drive the lift platform 5 and a person upward above the water line WL without problem.

The container 12 is equipped with a flotation volume and acts as a flotation body 10a and thus diverts the load away from the edge of the swimming pool basin 2. Likewise, the flotation body 10b on the guide rail 3 serves as an additional flotation body, so that the load on the floor of the swimming pool basin 2 can be kept low.

In order to reliably control the lifting H of the swimming pool lift 1, a sensor 24 is attached to the cable winch 20, for example, which detects the position of the lift platform 5 by means of the controller 25 and lifting to the corresponding desired position. If the lift platform 5 is in position B and the swimmer wishes to be lifted to the edge of the swimming pool basin 2 into position A, such a lifting control and controller is advantageous. Further, position C can also be elegantly approached and back again to position A, so that the lift platform 5 can be used in between as a diving platform, or other activities can be connected therewith, before then reassuming the neutral location, i.e. position A. If the lift platform 5 moves to position C, although the skimmer is out of the water, the water circulation and purification of the swimming pool basin 2 is ensured by means of the skimmer tube 14a.

For a long-lasting holding of a position, in particular position C, it occur that the lift platform 5 could sink over time, if no mechanical lock is mounted and activated. The actual/set point is continuously automatically checked by means of the controller 25. In a deviation above a determined level, the lift platform 5 is brought back to the set point.

Instead of a drive 6 with AC current and a cable 7 which is buried below ground, the swimming pool lift 1 may also be used autonomously, in that an interchangeable battery pack 8 is mounted on the swimming pool lift 1, while a battery pack 8 charges on a charging station, not shown here, on the premises, and thus always has a fully charged power source available, which ensures lifting and other services, such as LED lighting or a longer operation of a circulation pump, with a single battery charge. Of course, the battery pack 8 may be recharged by means of a solar system.

The guide rails 3 need not be vertically aligned, but may also be installed at an angle—with the corresponding adaptation of the guide rollers 4—in order to enable an improved pressure distribution on the guide rails 3, or for certain devices on the lifting platform 5 requiring more distance from the wall of the swimming pool basin 2 during diving, or the like. The drive 6 can also be installed in the container 12, in this case the drive 6 and the cable winch 20 are rotated by 90°. This also applies to the terrestrial version.

FIG. 2 shows a schematic side view of a swimming pool lift 1 on a swimming pool basin 2 filled with water W with guide rails 3, an adjusting ring 26 and guide slide bushings 4a on the lift platform 5, a hydraulic-based platform lifter 60 housed in the flotation body 10 consisting of a hydraulic cylinder 27, pump motor 28, valve 29, tank 30 and accumulator 31, as well as a cable winch reduction 33, consisting of a large cable winch 33a and a small cable winch 33b, wherein both may have divergent traction means. The cable winch translation 33 may have a connecting rod 34 to the other side of the lift platform 5, where a cable 9 is likewise connected with the guide rail 3. The securing of the raising upwards is ensured by means of a releasable adjusting ring 26, the holding safety 35 is ensured on the cable 9 through the brake 36 and the spring 37. The power supply to the pump motor 28 takes place by means of an inductive contact 32.

The lifting logic of the lift platform 5 for this swimming pool lift 1 is different than the variant described in FIG. 1, in that the flotation body 10 is made with a large volume, so that this can lift the lift platform 5 as well as the working weight at any time with its buoyancy V, namely above the neutral location A up to location C. For this reason, the cable 9 is fixed on the lower part of the guide rail 3 on the cable end 9 and the hydraulic cylinder 27 pulls the lift platform 5 downward, in order to move to location B, for example, or allows the cable 9—as a braking means—to slowly move until position C or any desired position there between is reached. The hydraulic cylinder 27 thus works only to bring the lift platform 5 downward; in the opposite direction, upwards, this works only as a hydraulic brake. At the same time, the hydraulic brake may also have an energy recuperating means, so that at least a part of the braking power is converted into electricity and becomes available for raising or other outputs. A mechanical brake 36 presses directly onto the guide rail 3 by means of the spring 37 and in swell holds the lift platform 5 in the desired position. Due to the tensioned cable 9, an undesired raising of the lift platform in the water is therefore not possible, but in heavy swell the lift platform 5 could dip into a corresponding wave trough. The cable 9 would thus relax, and in this moment the brake 36 grasps the holding safety 35 and holds the lift platform 5. In a smaller swimming pool basin 2, the waves do not work such that the lift platform 5 rocks, however in a hotel complex with a system built into the ocean, or on a raft, this safety is advantageous. Of course, the holding safety 35 may be actuated manually at any time, and the lift platform 5 may be deliberately locked. For the sake of security that the lift platform 5 always moves upward, even in an electrical black out, it is provided that the hydraulic system can be adjusted without pressure, and thus the lift platform 5 can always move upward to the adjusting ring 26. This serves to ensure that the lift platform 5 does not move further upward in an uncontrolled manner, however may be released, so that the lift platform 5 can be lifted further upward as needed to position C. The memory 31 provides that a plurality of full lifting upward and downward can be performed before the pump motor 28 must be switched on again. The power supply to the pump motor 28 can be supplied from the shore-side by means of a hanging cord or by means of a power cord in the cable as described by means of example in FIG. 5 or by means of an inductive contact 32. The transformer 32a makes DC current from AC current, for example 12 V or 24 V.

In order to allow the lift platform 5 to move optimally with the guide bushings 38 shown here, which may have a plastic coating or ball bearings or may constitute rollers, a second cable 9 is mounted on the opposite guide rod 3 and attached to the opposite cable winch 20 and connects both cable winches 20 with the transverse connecting rod 34. In this way, both the cable winches 20 act synchronously.

Ideally, the cable end 9a is to be had at the lowest point on the guide rail 3 with respect to the raising location, the electric or hydraulic drive under the lift platform 5 in the flotation body 10, whereby the cable winch 20 with the cable winch translation 33 can be placed vertically or horizontally. The cable 9 thereby remains fixed in its location and thus does not cause chafing against the guide rail 3, only the cable winch 20 rotates and changes the height of the lift platform 5.

The guide rail 3 may be round or square and may have an indentation, in which the cable 9 is thus not inset in a protruding manner.

FIG. 3 shows a schematic side view of a terrestrial lift 1a at an obstacle 46, with guide rails 3, guide bushings 38 on the lift platform 5 and a platform lifter 60 by means of the hydraulic system 39 in a covered banister side 40 with emergency control 41 and a motor-operated door 42, as well as a clasping of the lift platform 5 from below by means of a cable 9, which is guided by two transverse rollers 43, as well as a gas spring 44 parallel to the hydraulic cylinder 27 and a securing bolt 49 and a joint 50.

The terrestrial lift 1a is located on the guide rail 3, which terrestrial lift 1a features the same components as the swimming pool lift 1, only the arrangement is divergent, in that one of the two banister sides 40, which also serve as handrails and safeties against falling out, is fixed with the hydraulic system 39 in the cover 45 of the platform lifter 60 attached there. A respective transverse roller 43 is located on the left and right of the underside of the lift platform 5. The cable 9 passes from the large cable winch 33a, over the deflection roller 21 and the two transverse rollers 43 transversely to the other side to the cable end 9a, which is located on one of the two guide rails 3 and thus has a simultaneous pulley effect. Thus, with a single cable 9, the lift platform 5 can nevertheless be vertically displaced easily and synchronously on the guide bushings 38, as the cable forces are equally distributed in the arc of contact of the lift platform 5. Instead of as a handrail 3a, this part serves as a door carrier 47 and as the anchoring for the guide rail 3. The doors 42 can be opened and closed through forcible control or motorically, for example by means of a door cylinder 48.

General care for a cable breakage and becoming stuck between the outputs is achieved in that either the holding safety 35 as described in FIG. 2 is attached, or a securing bolt 49 is in place for this purpose which, in the case of a defect of the cable 9, engages, for example, at almost every location on the guide rail 3, either activated through the missing cable 9 or activated electronically, by means of an acceleration detection via an acceleration sensor. Fear of becoming stuck at an uncomfortable height above the ground is solved in that the hydraulic system 39 has an accumulator 31, on which the valve 29 can be manually activated by means of the emergency control 41 by means of a bowden cable 41a, whereby the securing bolt 49 is again released and the lift platform 5 can be lifted upward or downward, even multiple times, depending on the size of the accumulator 31. As an alternative, the possibility also exists of moving the lift platform 5 in a particular raising direction by means of a gas spring 44, in this case the hydraulic system 39 is set to atmospheric pressure and the securing bolt 49 is also pulled, so that the lift platform 5 can be easily moved without braking but with a predetermined lifting speed into a predetermined location. The lifting speed results from the nozzle opening in the gas cylinder 44 and thus defines the piston speed, as well as from the hydraulic cylinder 27 with respect to the cross-section of the hydraulic line, where the oil from the piston is guided out of the cylinder chamber into the tank 30.

In a terrestrial lift 1a, the placement of the electrical drive 6 or a hydraulic system 39 is possible at different locations, up to a system with an enclosed cabin, where such a drive 6 or hydraulic system 39, the controller 25 may be mounted on the cover of the cabin, so that the enclosed cabin may provide more space for passengers, the floor is wheelchair accessible and the terrestrial lift 1a does not require a cavity. Furthermore, a staircase, not shown here, can be attached to the joint 50 with horizontally positionally constant steps.

FIG. 4 shows a schematic side view of a hydraulic platform lifter 60 with an integrated hydraulic system 39, cable winch 20, cable winch reduction 33, hydraulic cylinder 27, controller 25, and a power connection by means of an inductive contact 32, as well as a bearing 54, hinge 52 and screw 53.

The heart of a compact swimming pool lift 1 or a terrestrial lift 1a is the inclusion of the electrical or hydraulic platform lifter 60, which does not restrict the user and at the same time is easily accessible for servicing. Mechanical translations, especially those by means of gears, are generally expensive, but not when a large cable winch 33a which is mounted on a base plate 51 is selected, which large cable winch 33a is used for winding and unwinding the cable 9 and in addition a central, small cable winch 33b is fixedly attached, on which a further cable 9 is likewise wound and unwound, wherein the cable 9 may also be a flat belt 99. This flat belt 99 is placed with a flat belt end 9d in the cable winch 33b and connected with the other end 9c to the hydraulic cylinder 27. The cable 9 is connected on one side at the cable end 9b with the large cable winch 33a and with the other cable end 9a to the guide rod 3. The differing diameters of the cable winches 33a, 33b result in the cable winch reduction 33. The advantage lies in the fact that, in order to bridge a lifting lift H of for example 250 cm with a swimming pool lift 1 or a terrestrial lift 1a, a diameter of the large cable winch 33a of for example 60 cm and the small cable winch 33b of 6 cm can be chosen, which results in a reduction ratio of 1:10 and thus the piston stroke K of the hydraulic cylinder 27 is only 25 cm. The inclusion of such a small hydraulic cylinder 27 may thus take place within the large cable winch 33a, and the compact hydraulic system 39 as is successfully used in large volumes in mobile devices of earthmoving equipment and trucks for lifting platforms may also find its place therein. In addition, an accumulator 31, as well as the controller 25 for a smart logic, such as pulse width modulation and controlling of the door cylinder 48, may also be accommodated therein. On the base plate 51, which may be mounted horizontally or vertically, the connection for the power supply may also be integrated or as an element, to which an inductive contact 32 can be attached. The bearing of the cable winches 33a, 33b occurs by means of the common bearing 54, which acts on the small cable winch 33b or on the large cable winch 33a. Little installation is thus required, and the cable winch reduction 33 is compactly and inexpensively supported. The base plate 51 may also be a part of the cover of a swimming pool lift 1 or a terrestrial lift 1a and may be removed or folded out for servicing purposes by means of the hinges 52 and screw 53.

FIG. 5 shows a schematic side view of a platform lifter 60 with integrated hydraulic, with the cable winch 33a, 33b, the pulley 58, controller 25 and the power supply through the power-supply cable 59.

The structure corresponds to the version shown in FIG. 4, with the exception that by means of a pulley 58, here with 2-fold reduction, whereby a higher number of reduction is also possible based on the number of deflection rollers 21 used, a power-supply cable 59 is attached to the pulley 58. This has the advantage that a fixedly installed consumption distributor 61 can be attached to one end of the power-supply cable 59, which consumption distributor 61 is used, for example, for the swimming pool cleaning system 11, LED lighting, pump motor and further electric consumers, and on the opposite side enables a simple power feed 62 directly into the power-supply cable 59. This additionally simplifies the displacement of the power-supply cable 59, as the power-supply cable 59 does not present a rotational movement, therefore a reduction, and at the same time the cable 9 can be wound and unwound without this resulting in a current tap in the rotating part of the cable winch 33a. Such an embodiment thus generates an elegant potency pulley, i.e. the reduction ratio of the pulley 58 is multiplied with the reduction ratio of the cable winch reduction 33.

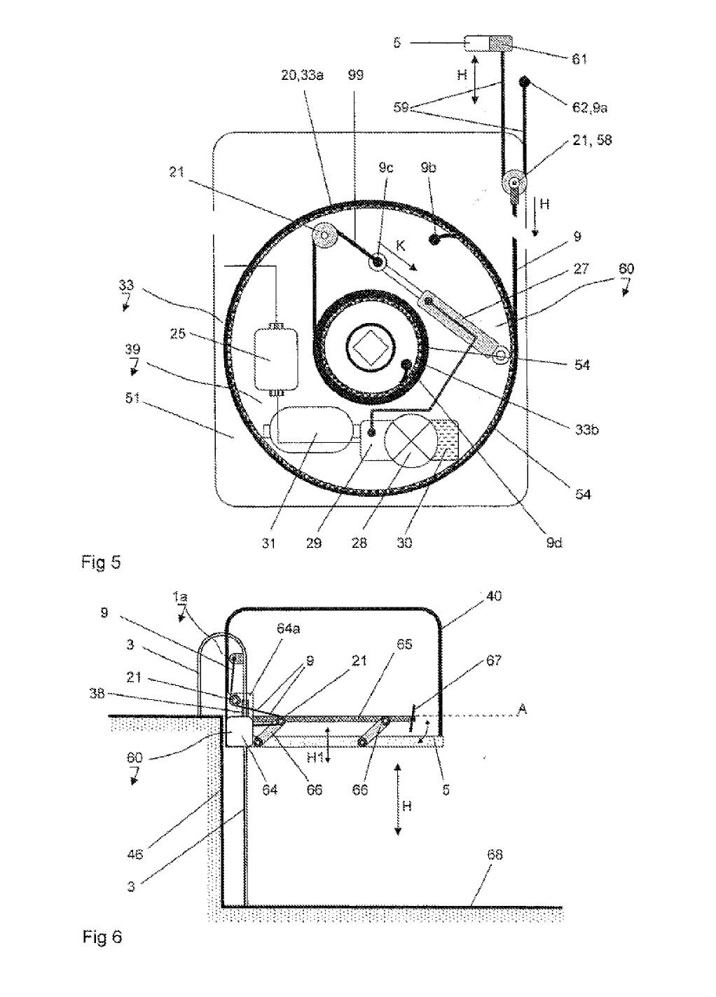

FIG. 6 shows a schematic side view of a terrestrial lift 1a and an obstacle 46, with guide rails 3, guide bushings 38, on which a lift platform 5 and a platform lifter 60 are located in a covered housing 64, as well as a double platform 65, each with two pivoting levers 66 and a stop plate 67 on both sides.

Such a construction is advantageous where no cavity can be created or, for reasons of cost and reasons of aesthetics, no housing can be laterally attached and a roof is not possible for the lift platform, into which the platform lifter 60 could then be integrated. One possibility is to apply the platform lifter 60 frontally, i.e. to the wall of the obstacle 46. Due to the fact that the platform lifter 60 represents a certain size and certain volume, no matter which type of reduction means are mounted therein, such a platform lifter 60 in a housing 64 would block entry and exit to the upper level of the lift platform 5. A lowering of the housing 64, so that the top thereof would be level with the lift platform 5, has the result that, during lowering of the terrestrial lift 1a, the lift platform 5 could not be completely lowered to the ground, as the housing 64 would first have contact with the ground and would block a further lifting H.

In order to solve the problem, a second platform, a double platform 65, is placed on the lift platform 5. The double platform 65 is connected to the lift platform 5 by means of a set of pivoting levers 66, which act as a parallelogram. The corresponding bearings are not shown, as these are representative of the state of the art with respect to a pivot bearing. The cable 9, which is fixed to the platform lifter 60 and wound thereon, causes that the deflection roller 21, during traction due to the arc of contact about the deflection roller 21, the double platform 65 is pulled up to the stop on the housing 64, after which the entirety, i.e. the double platform 65, lift platform 5, housing 64 and platform lifter 60, is lifted up to the upper level, which corresponds to position A. The deflection roller 21 is ideally mounted on the pivoting lever 66 and simultaneously on the double platform 65. The upper part of the housing 64 is a surface which can be walked on by people, wheelchairs and the like. The lower part of the housing is the boundary with the ground 68. The housing 64 has cusps 64a on the left and right, into which the guide bushings 38 are attached and the corresponding deflection rollers 21. In addition, the platform lifter 60 is embedded in the housing 64.

In this way, people may move safely from the upper level horizontally onto the lift platform 5 or vice versa, and wheelchairs may be pushed straight forward without obstacle.

In the lowermost position, the housing 64 stands on the ground 68 with the lift platform 5 and with the loosening of the cable 9, the pivoting lever 66, which holds the double platform 65, pivots and with a simultaneous loosening of the arc of contact about the deflection roller 21, the double platform 65 lowers onto the lift platform 5. Rubber dampers, not shown here, between the double platform 65 and the lift platform 5 cushion the lowering elegantly and quietly. In this way, people or a wheelchair may leave the terrestrial lift 1a comfortably, without a high and disruptive step or unnecessary reliance on the double platform 65.

Additionally, a stop plate 67 acts on the double platform 65. Such safety means are known in handicapped lift systems and fold out, locking automatically as soon as the system leaves the ground 68. Of course, a corresponding door 42 may also be attached to the terrestrial lift 1a, as well as to the upper level, position A.

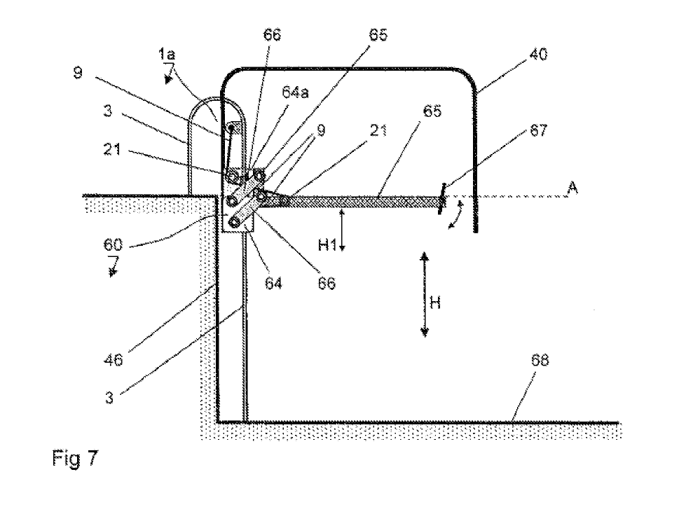

FIG. 7 shows a schematic side view of a terrestrial lift 1a at an obstacle 46, with guide rails 3, a platform lifter 60 in a covered housing 64 with cusp 64a, on which a movable double platform 65 with a stop plate 67 is located.

The raising principle can be compared with that shown in FIG. 6, wherein in this variant, the lifting platform 65 is absent and the pivoting arms 66 are attached to the cusp 64a. The pivoting arms 66, which act as a parallelogram, have a practically symmetrical raising articulation, so that, in the lower position on the ground 68, the double platform 65 practically abuts below against the housing 64, and abuts above against the housing 64, as soon as the double platform 65 is held in the upper level, position A. The cusps 64a are likewise mounted externally left and right of the housing 64, and thus do not limit the passageway.

Of course, the invention is not limited only to the embodiments shown and described.

### LIST OF REFERENCE CHARACTERS

1 swimming pool lift
1a terrestrial lift
2 swimming pool basin
3 guide rail
3a handrail
4 guide roller
4a guide slide bushing
5 lift platform
6 drive
7 cord
8 battery pack
9 cable
9a, 9b cable end
9c, 9d flat belt end
99 flat belts
10,a,b flotation body
11 swimming pool cleaning system
12 container
13 swimming pool wall
14 skimmer
14a skimmer tube
15 circulation pump
16 filter
17 metering device
18 lifting stop
19 crank opening
20 cable winch
21 deflection roller
22 lid
23 attachment
24 sensor
25 controller
26 adjusting ring
27 hydraulic cylinder
28 pump motor
29 valve
30 tank
31 accumulator
32 inductive contact
32a transformer
33 cable winch reduction
33a large cable winch
33b small cable winch
34 connecting rod
35 holding safety
36 brake
37 spring
38 guide bushing
39 hydraulic system
40 railing side
41 emergency control
41a Bowden cable
42 door
43 transverse roller
44 gas spring
45 cover
46 obstacle
47 door carrier
48 door cylinder
49 securing bolt
50 joint
51 base plate
52 hinge
53 screw
54 bearing
55 air bag
56 filling means
57 manual valve
58 pulley
59 power-supply cable
60 platform lifter
61 consumption distributor
62 power feed
63 fold-out diving board
64 housing
64a cusp
65 double platform
66 pivoting arm
67 stop plate
68 ground
H lifting
H1 small raising
W water
K piston stroke
V buoyancy

1. A lift,
wherein
the lift platform can be moved via the lifting on vertical or inclined guide rails and the platform lifter rolls and unrolls the cable or the power-supplying cable or the flat belt and with the inclusion of a double platform together with the pivoting arms and a housing, an additional small lifting occurs and the lifting is secured by means of a security disposition, the platform lifter has a cable reduction and a drive or hydraulic cylinder and, for the power-supplying cable, room exists in the housing or in the lift platform for a consumption distributor, as well as a swimming pool cleaning system, flotation body, fold-out diving board.

2. The lift according to claim 1,
wherein
space is present in the inner diameter of the large cable winch for the small cable winch with the flat belt or a second cable, the deflection roller, the hydraulic cylinder, the hydraulic system, the accumulator and, if present, the controller.

3. The lift according to claim 1,
wherein
the cable reduction either consists of the large cable winch and the small cable winch and forms the cable winch reduction, or a pulley consists of two or more deflection rollers or both combine to form a potency pulley.

4. The lift according to claim 1,
wherein
the swimming pool cleaning system comprises at least the following elements, which are a skimmer, skimmer tube, circulation pump, filter, metering device, disinfecting means, disinfecting device, waterproof lid.

5. The lift according to claim 1,
wherein
the hydraulic system consists of at least of the hydraulic cylinder, pump motor, valve and tank.

6. The lift according to claim 1,
wherein:
the current from land to the lift is introduced by means of a flexible cord or by means of an inductive contact, wherein in the inductive contact, the current is charged in a battery pack, or such that the pump motor fills the accumulator and the battery pack or the accumulator can execute the maximum lifting once or more than once.

7. The lift according to claim 1,
wherein
the security disposition comprises at least one of the following elements, which are an accumulator, holding safety, emergency control, gas spring, securing bolt, air bag.

8. The lift according to claim 1,
wherein
the emergency control comprises a bowden cable and thus actuates the valve for depressurization of the hydraulic system or the accumulator and the valve are activated for controlled lifting and sinking of the lift platform or the manual valve imparts the filling means in the air bag.

9. The lift according to claim 1,
wherein
the guide rail has a round or square tube or a tube with a recess, so that a cable or a flat belt can be inserted therein.

10. The lift according to claim 1,
wherein:
the guide means represent guide rollers or guide bushings and the latter have a rigid sliding surface or spheres.

11. The lift according to claim 1,
wherein
the lift is a swimming pool lift or a terrestrial lift.

12. The lift according to claim 1,
wherein
the flotation body is sealed and partially hollow or filled with foam.

13. The lift according to claim 1,
wherein
the electric drive has a lifting stop and a crank opening.

14. The lift according to claim 1,
wherein
the sensor, at a given deviation from the set point, the controller ensures that the lift platform returns to the set point.
